(19) United States
(12) Patent Application Publication
(10) Pub. No.: US 2007/0045486 A1
(43) Pub. Date: Mar. 1, 2007

(54) Ergonomic arm support for computer operators

(76) Inventors: Roger Stewart, Pittsburgh, PA (US); Richard Stewart, Pittsburgh, PA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/211,978

(22) Filed: Aug. 25, 2005

(51) Int. Cl. A47B 23/00; B43L 15/00

(52) U.S. Cl. 248/118.1; 108/43

(57) ABSTRACT

An arm support for ergonomically supporting the arms of a computer operator. This support is generally a block support dimensioned and contoured to be supported on and to span the lap of the computer operator while seated and to support upper portions of the lower arm portions of the operator proximal to or adjacent the elbows.

### BACKGROUND OF THE INVENTION

The present invention relates generally to computer peripheral equipment and more particularly to an arm support for ergonomically supporting the arms of a computer operator in order to reduce muscle stress while using a computer.

Computer keyboard operators experience muscle stress, particularly in the arm, shoulder and neck muscles, which when physically stressed for extended periods of time leads to the development of neuromuscular conditions such as headaches, neck, shoulder, upper back, arm and wrist pain, diffuse brachial radiculitis (radiating pain, discomfort and/or numbness and weakness extending into the arms and hands). Such muscle stress can also lead to carpal tunnel, which is the compression of nerves of the wrist, and Raynards Syndrome, which is the compression of circulatory veins and arteries and capillaries with increased pain.

Accordingly, proper support is required for normal neuromuscular function and health. However, presently available supports are inadequate. For example, wrist supports are available but they are of little help. Also, lap cushions have been used, but they still do not properly support the arms in a proper manner.

### SUMMARY OF THE INVENTION

The present inventor has discovered that supporting the arms proximal to the elbows is of greater benefit than support provided by the prior art and that such support provides reduced muscle stress of the entire upper body. In fact, it has been proven through clinical testing of muscular micro volt potentials and ohm resistance variations that the support of the present invention is superior to no support or wrist supports sampled over intermittent time intervals while working at the computer.

The arm support of the present invention is provided for ergonomically supporting the arms of a computer operator and the support is comprised of a block support dimensioned and contoured to be supported on and to span the lap of the computer operator while seated, and to further support upper portions of the lower arms proximal to the elbows. The support of the present invention thus provides the most support possible with the greatest flexibility of movement to decrease upper body muscle stress while working at a computer station. The support of the present invention is a free moving unit, comfortable, yet supportive to any weight or size of individual. In this regard, it has been noted that while seated any individual, no matter what height, has a distance or variable of one inch or less between the elbow and thigh when the arms are in the position of working at a computer keyboard that is positioned on a standard desk work area.

The bottom of the support is also preferably contoured to rest on the thighs of a sitting individual close to the abdomen. The abdomen contours and the leg or lap contours also add stability to the unit prohibiting it from sliding off the lap.

The support may be a bottom support block constructed of any conventional materials. For example, the base of the support may be constructed of a plastic cellular foam with a separate injected plastic top plate which is secured to the foam base. In another example the entire arm support of the present invention may be constructed with plastic blow molding techniques.

### BRIEF DESCRIPTION OF DRAWINGS

Other objects and advantages appear hereinafter in the following description and claims. The accompanying drawings show, for the purpose of exemplification, without limiting the invention or appended claims, certain practical embodiments of the present invention wherein:

FIG. 1 is a perspective view of the arm support of the present invention.

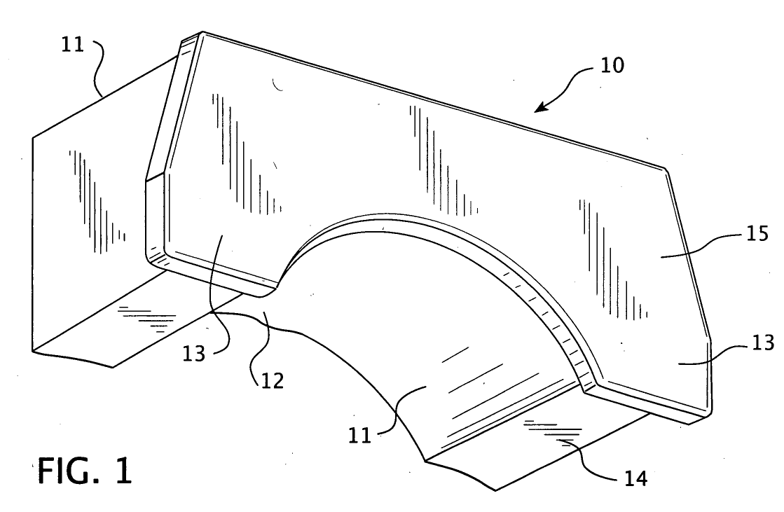

FIG. 2 is an exploded view showing the arm support of FIG. 1 in two pieces, a top plate and a bottom support block; and

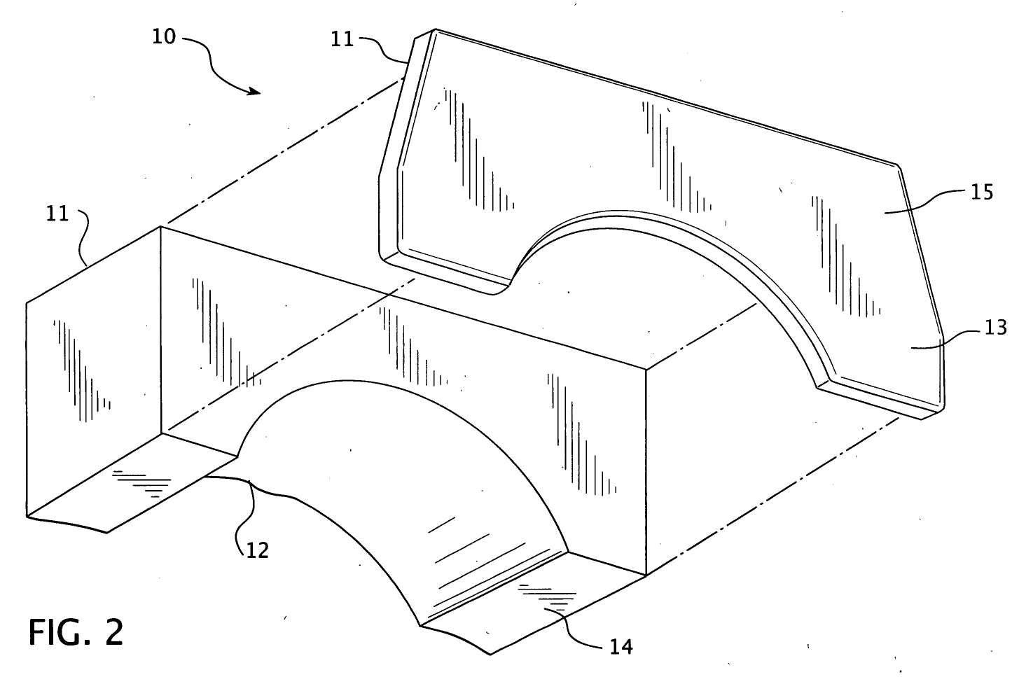

FIG. 3 is a view in front elevation of the bottom support block shown in FIG. 2.

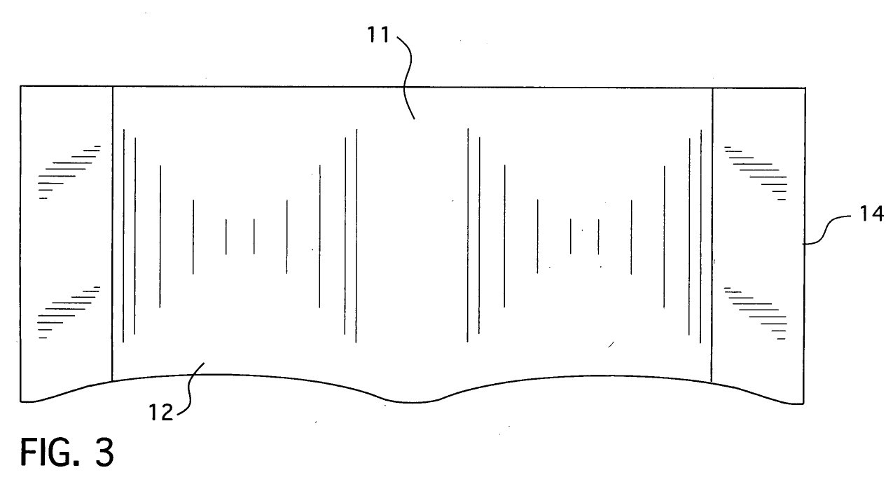

### DETAILED DESCRIPTION OF A PREFERRED EMBODIMENT

Referring to the drawings, the arm support 10 is designed for ergonomically supporting the arms of a computer operator and is comprised of a block support 11 dimensioned to be supported and to span the lap of a computer operator while seated. In fact, the bottom portion 12 of the block 11 is contoured to fit the lap of the operator and in addition, the back side 13 of the block 11 is contoured to receive the abdominal portion of the seated computer operator whereby the arm support 10 of the present invention is positioned such that upper portions of the lower arm portions of the operator are supported proximate to or adjacent to the elbows at areas 13 of the support 10.

The support 10 in this embodiment is constructed in two parts wherein the bottom portion 12 is constructed of a suitable plastic foam, such as polyurethane foam with a specific density of 1.6 to 3.4 pounds which allows comfort on the thighs yet supportive enough for any weight applied by arm pressure. The top plate 15 is also contoured around the abdomen area to allow for variable movement of the arms with continued support and is made of durable polyurethane plastic which is most easily made by injection molding techniques. Other materials may be used, such as plexiglass. This top plate also assures durability of the unit with constant use and movement of the arms upon the top plate 15.

However, the support 10 of the present invention may also be constructed by other suitable methods, such as by plastic blow molding techniques in a single unit.

1. An arm support for ergonomically supporting the arms of a computer operator, the support comprising:
a rigid block support dimensioned and contoured to be supported on and to span the lap of a computer operator while seated, and to support upper portions of the lower arm portions of the operator adjacent the elbows.

2. The arm support of claim 1, wherein said block support is contoured to circumvent the stomach portion of the operator.

3. The arm support of claim 2, wherein said support is contoured on a bottom side thereof to conform to the operator's lap.

4. The arm support of claim 1, wherein said block support is composed of a foam block having a plastic top plate secured thereto.

5. The arm support of claim 4, wherein said top plate overextends said foam block on opposite ends for engaging said upper arm portion.

6. The arm support of claim 1, wherein said block support is composed of hollow plastic formed by blow mold or injection mold techniques.
